(19) United States
(12) Patent Application Publication
(10) Pub. No.: US 2022/0371492 A1
(43) Pub. Date: Nov. 24, 2022

(54) VEHICLE SEAT CONTAINING FIBER COMPOSITE MATERIAL AND EXPANDED THERMOPLASTICS

(71) Applicant: COVESTRO INTELLECTUAL PROPERTY GMBH & CO. KG, Leverkusen (DE)

(72) Inventors: Andreas KLEIN, Leverkusen (DE); Ulrich GROSSER, Kürten (DE); Felix BAUDACH, Leverkusen (DE)

(21) Appl. No.: 17/765,580

(22) PCT Filed: Oct. 7, 2020
(86) PCT No.: PCT/EP2020/078035

§ 371 Date: Mar. 31, 2022

(30) Foreign Application Priority Data
Oct. 7, 2019 (EP) 19201600.4

(51) Int. Cl. B60N 2/70; B60N 2/68; B29C 69/02; B29C 70/46; B29C 51/14; B29C 51/00; B29C 44/44; B29C 44/14; B29D 99/00; B32B 7/08; B32B 5/20; B32B 5/12; B32B 27/06; B32B 27/08; B32B 27/36

(52) U.S. Cl. CPC B60N 2/7011; B60N 2/686; B60N 2/7017; B29C 69/02; B29C 70/46; B29C 51/145; B29C 51/002; B29C 44/44; B29C 44/14; B29D 99/0092; B32B 7/08; B32B 5/20; B32B 5/12; B32B 27/065; B32B 27/08; B32B 27/365; B29K 2105/048

(57) ABSTRACT

The invention relates to a seat for a vehicle, preferably for a land craft, a watercraft, and/or an aircraft, comprising at least one multilayer structural component (1) with at least one first (6) and at least one second ply (5) of a composite material, in each case containing fibers which are integrated into a thermoplastic, and with a layer (7) which is arranged between said plies and is made of at least one foamed thermoplastic; to a method for producing same, said method having at least the following steps (A): providing at least one first and at least one second ply of a composite material, in each case containing fibers which are integrated into a thermoplastic, (B) thermoforming the first ply of composite material into a lower seat shell, (C) thermoforming the second ply of composite material into an upper seat shell, (D) arranging the lower seat shell and the upper seat shell in a tool, such that a gap is formed between the two seat shells, (E) introducing foamed particles made of a thermoplastic into the gap, and (F) pressing the two seats shells and the foamed particles in order to obtain the seat; and to the use of the seat in a vehicle, preferably in a land craft, a watercraft, and/or an aircraft.

The present invention relates to a seat for a vehicle, preferably for a land vehicle, for a watercraft and/or for an aircraft, comprising at least one multilayer structural component comprising at least one first layer and at least one second layer of composite material, in each case containing fibers which are embedded in a thermoplastic polymer, and a layer of at least one foamed thermoplastic polymer arranged in between, a process for the production thereof, comprising at least the following steps (A) provision of at least one first layer and at least one second layer of composite material, in each case containing fibers which are embedded in a thermoplastic polymer, (B) thermoforming of the at least one first layer of composite material to form a lower seat shell, (C) thermoforming of the at least one second layer of composite material to form an upper seat shell, (D) positioning of the lower seat shell and the upper seat shell in a tool so that a gap is formed between the two seat shells, (E) introduction of foamed particles of a thermoplastic polymer into the gap and (F) pressing together of the two seat shells and the foamed particles in order to obtain the seat. Furthermore, the present invention relates to the use of the seat in a vehicle, preferably in a land vehicle, in a watercraft and/or in an aircraft.

The document WO 2015/044099 discloses a multilayer structural component comprising a first fiber composite layer and a second fiber composite layer and a layer of foamed polymer arranged in between, where the first fiber composite layer and the second fiber composite layer each comprise at least one fiber layer composed of a fiber material which is embedded in a matrix based on a thermoplastic polymer, in particular in a thermoplastic polyurethane. Furthermore, a description is given of a process for producing the component, in which a first fiber composite sheet and a second fiber composite sheet are provided, these are thermoformed to give appropriate fiber composite semifinished parts and these semifinished parts are arranged in a foaming tool so that a hollow space is formed between the semifinished parts. This hollow space is filled by injection of a polymer mixture which foams in the gap. The density of the resulting foamed core is said to be from 50 to 600 kg/m³. Furthermore, the use of these structural components as bodywork parts is disclosed.

The document JP2019072859 discloses a sandwich material having a high impact toughness for applications in transport, as construction material or in household applications. For this purpose, a layer of a thermoplastic foam material is embedded between two layers of reinforced thermoplastic polymer. As thermoplastic polymers, propylene-based polymers are disclosed first and foremost.

The present-day structure of a seat in a vehicle, in particular in a motor vehicle, comprises various parts, preferably at least one seat part and at least one backrest part which each have a frame which is obtained from appropriately dimensioned metal tubes by bending and welding. The individual parts of this known vehicle seat are joined to one another by spring elements, in particular steel springs. Molded parts obtained by injection molding are attached to this metal frame and a layer of a polyurethane foam is subsequently applied. A seat covering made of material is then laminated onto the entire structure. The back wall of the seat is usually provided with a cover made of an injection molded material which may additionally be surface-coated. The disadvantages of such a construction are the high weight, the use of a large number of components, the necessity of joining many different parts to one another and also the problem that many different materials are present in such a seat, which makes recycling considerably more difficult.

It would be desirable to make available a seat for use in a vehicle, which seat has a slim construction which corresponds to the design trends prevailing at the present time. At the same time, however, the seat has to fulfil the present-day safety requirements. Furthermore, the seat should have a reduced number of individual parts and have a low overall weight combined with a high seating comfort. The material used in the seat should also display a favorable burning behavior and low emissions (fog A and fog B).

It is therefore an object of the present invention to provide a vehicle seat which has a slim construction corresponding to the design trends prevailing at the present time and at the same time fulfils the present-day safety requirements, in particular in respect of mechanical strength. Furthermore, the seat should have a reduced number of individual parts and have a low overall weight combined with a high seating comfort. The material used in the seat should also display a favorable burning behavior and low emissions (fog A and fog B).

These objects are achieved according to the invention by a seat for a vehicle, preferably for a land vehicle, for a watercraft and/or for an aircraft, comprising at least one multilayer structural component comprising at least one first and at least one second layer of composite material, in each case containing fibers which are embedded in a thermoplastic polymer, and a layer of at least one foamed thermoplastic polymer arranged in between, wherein the number of first and second layers of composite material present on the front side and the rear side of the seat according to the invention and/or in different regions of the seat, for example the backrest part, seat part and the region connecting the backrest part and the seat part, is not the same.

The objects are also achieved according to the invention by a seat for a vehicle, preferably for a land vehicle, for a watercraft and/or for an aircraft, comprising at least one multilayer structural component comprising at least one first and at least one second layer of composite material, in each case containing fibers which are embedded in a thermoplastic polymer, and a layer of at least one foamed thermoplastic polymer arranged in between, wherein the fibers are in each case unidirectionally oriented continuous fibers and the unidirectionally oriented continuous fibers in the at least one first layer and/or in the at least one second layer are arranged parallel to one another or at an angle of from 300 to 130° to one another in various parts of the seat according to the invention, where the individual angles can be different.

The objects are also achieved by the seat according to the invention for a vehicle, preferably for a land vehicle, for a watercraft and/or for an aircraft, comprising at least one multilayer structural component comprising at least one first and at least one second layer of composite material, in each case containing fibers which are embedded in a thermoplastic polymer, and a layer of at least one foamed thermoplastic polymer arranged in between.

Furthermore, the objects are achieved by the process according to the invention for producing a corresponding seat, comprising at least the following steps:
(A) provision of at least one first and at least one second layer of composite material, in each case containing fibers which in each case are embedded in a thermoplastic polymer,
(B) thermoforming of the at least one first layer of composite material to form a lower seat shell,
(C) thermoforming of the at least one second layer of composite material to form an upper seat shell,
(D) positioning of the lower seat shell and the upper seat shell in a tool so that a gap is formed between the two seat shells,
(E) introduction of foamed particles composed of a thermoplastic polymer into the gap and
(F) pressing together of the two seat shells and the foamed particles in order to obtain the seat.

The objects are also achieved by the use of the seat according to the invention in a vehicle, preferably in a land vehicle, in a watercraft and/or in an aircraft.

The present invention is described in detail below:

The present invention relates to a seat for a vehicle, preferably for a land vehicle, for a watercraft and/or for an aircraft, comprising at least one multilayer structural component comprising at least one first and at least one second layer of composite material, in each case containing fibers which are embedded in a thermoplastic polymer, and a layer of at least one foamed thermoplastic polymer arranged in between.

The seat according to the invention is generally suitable for any vehicle known to a person skilled in the art, in particular for a land vehicle, for a watercraft and/or for an aircraft. Examples according to the invention of land vehicles are motor vehicles and goods vehicles. Examples according to the invention of watercraft are ships, ferries and cruise ships. Examples according to the invention of aircraft are airplanes and helicopters. The seat according to the invention can be arranged in any position available in the respective vehicle, for example as driver's seat or pilot's seat or as passenger seat.

The seat according to the invention comprises at least one multilayer structural component.

In a possible embodiment, the seat according to the invention comprises more than one, i.e. two, three, four or more, such multilayer structural components. For example, such a structural part in a seat according to the invention can form the seat part and a further correspondingly configured structural part can form the backrest part. In this embodiment, the structural parts present are connected to one another by connections known to a person skilled in the art, for example using hinges or springs.

In a preferred embodiment, the present invention provides the seat according to the invention, wherein the seat consists of an appropriately shaped, multilayer structural component. In this preferred embodiment, the seat according to the invention is made in one piece, i.e. the entire seat consists of an appropriately shaped, multilayer structural component.

In a further preferred embodiment of the present invention, the multilayer structural component therefore comprises a backrest part, a seat part and a region connecting the backrest part and the seat part. In a further preferred embodiment, the multilayer structural component consists of a backrest part, a seat part and a region connecting the backrest part and the seat part.

The seat according to the invention can generally have any dimensions which appear suitable to a person skilled in the art. The width of the seat according to the invention is, for example, from 380 to 495 mm, preferably from 440 to 450 mm. The height of the seat according to the invention is, for example, from 900 to 1200 mm, preferably from 910 to 930 mm. The depth of the seat according to the invention is, for example, from 500 to 700 mm, preferably from 620 to 640 mm.

The thickness of the layer of at least one foamed thermoplastic polymer arranged between the at least one first layer of composite material and the at least one second layer of composite material is generally from 2 to 300 mm, preferably from 5 to 150 mm, particularly preferably from 10 to 100 mm. According to the invention, the thickness of this layer can be identical over the entire seat. In a further embodiment according to the invention, the thickness of this layer is not identical over the entire seat but instead varies by 50% of the maximum thickness.

According to the invention, it is possible and preferred that the thickness of the layer of at least one foamed thermoplastic polymer of the seat part which is arranged between the at least one first layer of composite material and the at least one second layer of composite material is smaller on the side facing away from the connecting region, i.e. at the lower end of the seat part, than the thickness in the vicinity of the connecting region. Furthermore, it is preferred that the thickness of the layer of at least one foamed thermoplastic polymer of the backrest part which is arranged between the at least one first layer of composite material and the at least one second layer of composite material is smaller on the side facing away from the connecting region, i.e. at the upper end of the backrest part, than the thickness in the vicinity of the connecting region.

The angle between seat part and backrest part of the seat according to the invention can generally assume all values which appear to be suitable to a person skilled in the art; for example, the angle between seat part and backrest part of the seat according to the invention is from 800 to 150°, preferably from 1000 to 110°.

The thickness of the seat according to the invention, in particular of the seat part, of the backrest part and/or of the region connecting the seat part and the backrest part, can generally assume any value which appears to be suitable to a person skilled in the art; for example, the thickness of the seat according to the invention, in particular of the seat part, of the backrest part and/or of the region connecting the seat part and the backrest part, is from 5 to 200 mm, preferably from 10 to 50 mm.

According to the invention, it is possible and preferred that the thickness of the seat according to the invention is not identical over the entire component but instead varies within the abovementioned limits. Particular preference is given to the thickness of the seat part on the side facing away from the connecting region, i.e. at the lower end of the seat part, being smaller than the thickness in the vicinity of the connecting region. Furthermore, it is preferred that the thickness of the backrest part on the side facing away from the connecting region, i.e. at the upper end of the backrest part, is smaller than the thickness in the vicinity of the connecting region. The regions present in the seat according to the invention can also have different thicknesses in different places, for example in order to be more stable or less stable in certain places during use and/or in the case of deformation of the seat during an accident. The differences in the thicknesses at the places described here in the seat according to the invention are, for example, from 2 to 80%, preferably from 20 to 40%.

The seat according to the invention, in particular the individual regions present, for example seat part, backrest part and the region connecting the seat part and the backrest part, can generally have any shape which appears to be suitable to a person skilled in the art, for example standard seats or sports seats.

Furthermore, it is possible according to the invention for openings to be present in the seat according to the invention, in particular in the individual regions present, for example seat part, backrest part and the region connecting the seat part and the backrest part, i.e. the corresponding regions are not formed continuously by the abovementioned materials but instead there are free regions, for example in order to save weight and/or to allow or improve the view in a backward direction for the driver of the vehicle. These openings make up from 2% to 50%, preferably from 5% to 20%, of the area of the respective component in a preferred embodiment.

Apart from the components of the seat according to the invention explicitly described here, in particular the structural part according to the invention, this seat can generally have all further fixtures, connections, devices, etc., known to a person skilled in the art. Examples here are retention systems, in particular seat belts, sensors, devices for fastening the seat according to the invention to the vehicle, electric connections, headrests, seat heating.

The structural component present in the seat according to the invention comprises at least one first layer and at least one second layer of composite material, in each case containing fibers which are embedded in a thermoplastic polymer.

According to the invention, any composite material which contains fibers embedded in a thermoplastic polymer and is known to a person skilled in the art can generally be used for the abovementioned at least one first and at least one second layer.

As fibers, it is possible, according to the invention, to use all fibers known to a person skilled in the art, for example selected from the group consisting of continuous fibers, textile sheet structures, in particular woven fabrics, and mixtures thereof.

According to the invention, the thermoplastic polymer is preferably selected from the group consisting of polycarbonate, polyamide, polypropylene, styrene-acrylonitrile copolymer (SAN), thermoplastic polyurethane, acrylic acid-butadiene-styrene copolymer (ABS), particularly preferably polycarbonate, very particularly preferably homopolycarbonate and/or copolycarbonate.

In a preferred embodiment of the present invention, a composite material containing continuous fibers is used for each of the at least one first layer and the at least one second layer, with the continuous fibers being oriented unidirectionally within the respective layer and being embedded in a polymer based on homopolycarbonate and/or copolycarbonate.

In this preferred embodiment, the proportion by volume of fibers in the respective layer of composite material is from 10 to 80% by volume, particularly preferably from 20 to 30% by volume, very particularly preferably from 30 to 60% by volume.

For the purposes of the invention, the term “continuous fibers” is used to distinguish from the short or long fibers which are likewise known to a person skilled in the art. Continuous fibers generally extend over the total length of the layer of composite material. The term continuous fibers arises from the fact that these fibers are present rolled up on a roll and are preferably wound off and impregnated with polymer during production of the individual composite material layers, so that, with the exception of an occasional break or change of roll, their length usually corresponds essentially to the length of the composite material layer produced.

Preference is given to continuous fibers being present in the layers of composite material which are present according to the invention. According to the invention, the continuous fibers present are preferably selected from the group consisting of glass fibers, carbon fibers, basalt fibers, polymer fibers, specialty fibers and mixtures thereof, in particular carbon fibers and/or glass fibers.

The polymer fibers used as continuous fibers are more preferably selected from the group consisting of liquid crystal polymer fibers, aramid fibers, polyphenylene sulfide fibers, polyether ketone fibers, polyether ether ketone fibers, polyetherimide fibers and mixtures thereof.

Very particular preference is given to using carbon fibers having an E modulus of greater than 240 GPa, preferably greater than 245 GPa, particularly preferably 250 GPa or more, as continuous fibers. Such carbon fibers are commercially available, for example, under the name Pyrofil from Mitsubishi Rayon CO., Ltd. Practical tests have shown that these carbon fibers display particularly good spreadability during processing to give a composite material layer according to the invention.

In a preferred embodiment, the present invention provides the seat according to the invention in which the fibers are continuous fibers which are unidirectionally aligned within the respective layer.

For the purposes of the present invention, “unidirectional” means that the continuous fibers essentially have their length pointing in one direction and thus run in the same direction. For the present purposes, “essentially unidirectionally” means that a deviation from the direction in which the fibers run of up to 5% is possible. However, the deviation in the direction in which the fibers run is preferably significantly below 3%, particularly preferably significantly below 1%.

The at least one first layer and the at least one second layer which are present according to the invention each generally have a thickness of from 30 to 1000 μm, preferably from 50 to 500 μm, particularly preferably from 80 to 300 μm.

The at least one first layer and the at least one second layer used according to the invention can be produced using the customary methods known to a person skilled in the art for producing fiber composite materials.

In a preferred embodiment of the invention, the layers of composite material present can be produced by application of a molten poly carbonate-based polymer to a preheated continuous fiber tape with application of pressure, shear and vibration. Such a production process is described in DE 10 2011 005 462 B3. For the purposes of the invention, a continuous fiber tape is a plurality of rovings which have been brought together, with the rovings being untwisted bundles of many continuous fibers.

In a preferred embodiment, the present invention provides the seat according to the invention in which the fibers, preferably the continuous fibers, in the composite material are embedded in a polymer based on homopolycarbonate and/or copolycarbonate.

For the purposes of the present invention, a poly carbonate-based polymer is a polymer which contains at least 50% by weight, preferably at least 60% by weight, more preferably at least 70% by weight, in particular at least 80% by weight, particularly preferably at least 90% by weight, very particularly preferably at least 95% by weight, in particular at least 97% by weight, of polycarbonate. In other words, a polycarbonate-based polymer can, for the purposes of the present invention, contain not more than 50% by weight, preferably not more than 40% by weight, more preferably not more than 30% by weight, in particular not more than 20% by weight, particularly preferably not more than 10% by weight, very particularly preferably not more than 5% by weight, in particular not more than 3% by weight, of one or more polymers other than polycarbonate as blend partners.

In a particular embodiment, the polycarbonate-based polymer consists essentially, in particular to an extent of 100% by weight, of polycarbonate.

When reference is made in the context of the present invention to polycarbonate, this also encompasses mixtures of various polycarbonates. Furthermore, the term polycarbonate is used here as umbrella term and thus encompasses both homopolycarbonates and copolycarbonates. The polycarbonates can also be linear or branched, in a known manner.

In a particular embodiment of the invention, the polycarbonate-based polymer consists to an extent of 70% by weight, 80% by weight, 90% by weight or essentially, in particular to an extent of 100% by weight, of a linear polycarbonate.

The polycarbonates may be produced in known fashion from diphenols, carbonic acid derivatives and optionally chain terminators and branching agents.

Particulars pertaining to the production of polycarbonates have been well known to a person skilled in the art for at least about 40 years. Reference may here be made by way of example to D. Freitag, U. Grigo, P. R. Müller, H. Nouvertné, BAYER AG, Polycarbonates in Encyclopedia of Polymer Science and Engineering, Volume 11, Second Edition, 1988, pages 648 to 718, and to U. Grigo, K. Kirchner and P. R. Müller “Polycarbonate” in Becker/Braun, Kunststoff-Handbuch, volume 31, Polycarbonate, Polyacetale, Polyester, Celluloseester, Carl Hanser Verlag Munich, Vienna 1992, pages 117 to 299.

The production of aromatic polycarbonates is carried out, for example, by reaction of diphenols with carbonyl halides, preferably phosgene, and/or with aromatic dicarboxylic acid dihalides, preferably benzenedicarboxylic acid dihalides, by the phase interfacial process, optionally using chain terminators and optionally using trifunctional or more than trifunctional branching agents. Production via a melt polymerization process by reaction of diphenols with, for example, diphenyl carbonate is likewise possible. Diphenols suitable for the production of the polycarbonates are for example hydroquinone, resorcinol, dihydroxydiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from isatin derivatives or from phenolphthalein derivatives, and also the related ring-alkylated, ring-arylated and ring-halogenated compounds.

Diphenols which are preferably employed are those based on phthalimides, for example 2-aralkyl-3,3′-bis(4-hydroxyphenyl)phthalimides or 2-aryl-3,3′-bis(4-hydroxyphenyl)phthalimides such as 2-phenyl-3,3′-bis(4-hydroxyphenyl)phthalimide, 2-alkyl-3,3′-bis(4-hydroxyphenyl)phthalimides, such as 2-butyl-3,3′-bis(4-hydroxyphenyl)phthalimides, 2-propyl-3,3′-bis(4-hydroxyphenyl)phthalimides, 2-ethyl-3,3′-bis(4-hydroxyphenyl)phthalimides or 2-methyl-3,3′-bis(4-hydroxyphenyl)phthalimides and also diphenols based on isatins substituted at the nitrogen such as 3,3-bis(4-hydroxyphenyl)-1-phenyl-1H-indol-2-one or 2,2-bis(4-hydroxyphenyl)-1-phenyl-1H-indol-3-one.

Preferred diphenols are 4,4′-dihydroxybiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane.

Particularly preferred diphenols are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane and dimethylbisphenol A.

These and other suitable diphenols are described, for example, in U.S. Pat. Nos. 3,028,635, 2,999,825, 3,148,172, 2,991,273, 3,271,367, 4,982,014 and 2,999,846, in DE-A 1 570 703, DE-A 2 063 050, DE-A 2 036 052, DE-A 2 211 956 and DE-A 3 832 396, in FR-A 1 561 518, in the monograph H. Schnell, Chemistry and Physics of Polycarbonates, Interscience Publishers, New York 1964 and also in JP-A 620391986, JP-A 620401986 and JP-A 1055501986.

In the case of homopolycarbonates, only one diphenol is employed, and in the case of copolycarbonates, two or more diphenols are employed.

Examples of suitable carbonic acid derivatives are phosgene or diphenyl carbonate.

Suitable chain terminators that may be used in the production of the polycarbonates are monophenols. Suitable monophenols are for example phenol itself, alkylphenols such as cresols, p-tert-butylphenol, cumylphenol and mixtures thereof.

Preferred chain terminators are phenols which are monosubstituted or polysubstituted by linear or branched, preferably unsubstituted C1-C30-alkyl radicals or by tert-butyl. Particularly preferred chain terminators are phenol, cumylphenol and/or p-tert-butylphenol. The amount of chain terminator to be used is preferably from 0.1 to 5 mol %, based on moles of diphenols used in each case. The chain terminators can be added before, during or after the reaction with a carbonic acid derivative.

Suitable branching agents are the trifunctional or more than trifunctional compounds known in polycarbonate chemistry, in particular those having three or more than three phenolic OH groups.

Suitable branching agents are, for example, 1,3,5-tri(4-hydroxyphenyl)benzene, 1,1,1-tri(4-hydroxyphenyl)ethane, tri(4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane and 1,4-bis((4′,4-dihydroxytriphenyl)methyl)benzene and 3,3-bis(3-methyl-4-hydroxyphenyl)-2-oxo-2,3-dihydroindole.

The amount of the branching agents for optional use is preferably from 0.05 mol % to 3.00 mol %, based on moles of diphenols used in each case. The branching agents can either be initially charged with the diphenols and the chain terminators in the aqueous alkaline phase or be added dissolved in an organic solvent before the phosgenation. In the case of the transesterification process, the branching agents are employed together with the diphenols.

Particularly preferred polycarbonates are the homopolycarbonate based on bisphenol A, the homopolycarbonate based on 1,3-bis(4-hydroxyphenyl)-3,3,5-trimethylcyclohexane and the copolycarbonates based on the two monomers bisphenol A and 1,1-bis(4-hydroxyphenyl)-3,3,5-trimethylcyclohexane.

Furthermore, copolycarbonates can also be used. To produce these copolycarbonates, it is possible to use from 1 to 25% by weight, preferably from 2.5 to 25% by weight, particularly preferably from 2.5 to 10% by weight, based on the total amount of diphenols to be used, of poly diorganosiloxanes having hydroxyaryloxy end groups. These are known (U.S. Pat. Nos. 3,419,634, 3,189,662, EP 0 122 535, U.S. Pat. No. 5,227,449) and can be produced by methods known in the literature. Likewise suitable are polydiorganosiloxane-containing copolycarbonates; the production of the polydiorganosiloxane-containing copolycarbonates is described, for example, in DE-A 3 334 782.

The polycarbonates may be present alone or as a mixture of polycarbonates. It is also possible to use the polycarbonate or the mixture of polycarbonates together with one or more polymers other than polycarbonate as blend partners.

As blend partners, it is possible to use polyamides, polyesters, in particular polybutylene terephthalate and polyethylene terephthalate, polylactide, polyether, thermoplastic polyurethane, polyacetal, fluoropolymer, in particular polyvinylidene fluoride, polyether sulfones, polyolefin, in particular polyethylene and polypropylene, polyimide, polyacrylate, in particular poly(methyl)methacrylate, polyphenylene oxide, polyphenylene sulfide, polyether ketone, polyaryl ether ketone, styrene polymers, in particular polystyrene, styrene copolymers, in particular styrene-acrylonitrile copolymer, acrylonitrile-butadiene-styrene block copolymers and polyvinyl chloride.

In addition, up to 10.0% by weight, preferably from 0.10 to 8.0% by weight, particularly preferably from 0.2 to 3.0% by weight, of other customary additives are optionally present. Additives which are suitable for the purposes of the invention are, for example, selected from the group consisting of flame retardants, anti-drip agents, thermal stabilizers, mold release agents, antioxidants, UV absorbers, IR absorbers, antistatics, optical brighteners, light-scattering agents, colorants such as pigments, including inorganic pigments, carbon black and/or dyes, inorganic fillers and mixtures thereof. These additives may be added individually or else in a mixture.

Additives of this type which are customarily added to polycarbonates are described, for example, in EP-A 0 839 623, WO-A 96/15102 or EP-A 0 500 496.

Homopolycarbonate- and/or copolycarbonate-based polymers which are preferably used according to the invention generally having a melt viscosity which ensures good processability according to the present invention. In a preferred embodiment, the homopolycarbonate- and/or copolycarbonate-based polymers used have a melt viscosity of from 100 to 2000 Pa*s, more preferably from 130 to 1300 Pa*s. The determination of the melt viscosity is carried out using the high-pressure capillary rheometer as set forth in ISO 11443 of 04-2014.

Homopolycarbonate- and/or copolycarbonate-based polymers which are preferably used according to the invention generally have a molecular weight which ensures good processability according to the present invention. In a preferred embodiment, the homopolycarbonate- and/or copolycarbonate-based polymers used have a molecular weight of from 24 000 to 33 000 g/mol, more preferably from 26 000 to 31 000 g/mol. The determination of the molecular weight is carried out by GPC analysis in accordance with DIN EN ISO/IEC 17025 of 03-2018.

The at least one first layer of composite material and the at least one second layer of composite material which are present according to the invention can in each case have a symmetric or asymmetric structure. In this context, “symmetric” means that the continuous fibers present are embedded from both sides in essentially the same amounts of a thermoplastic polymer. In this context, “asymmetric” means that the continuous fibers present are embedded from both sides with different amounts of a thermoplastic polymer, so that the continuous fibers are closer to the surface of the one side of the first layer than to the surface of the other side of the first layer.

In a preferred embodiment, the present invention provides the seat according to the invention in which more than one first layer or more than one second layer of composite material are present on top of one another. For example, 1, 2, 3, 4, 5, 6, 7, 8, 9 or 10 first layers of composite material and 1, 2, 3, 4, 5, 6, 7, 8, 9, 10 second layers of composite material can be present in the seat according to the invention.

The present invention provides a seat for a vehicle, preferably for a land vehicle, for a watercraft and/or for an aircraft, comprising at least one multilayer structural component comprising at least one first and at least one second layer of composite material, in each case containing fibers which are embedded in a thermoplastic polymer, and a layer of at least one foamed thermoplastic polymer arranged in between, wherein the number of first and second layers of composite material present on the front side and the rear side of the seat according to the invention and/or in various regions of the seat, for example backrest part, seat part and the region connecting the backrest part and the seat part, is not the same, i.e. there are different numbers of first and second layers present, i.e. the number differs by at least 1. The different number of layers on the front side and the rear side of the seat according to the invention result in correspondingly different thicknesses of these components.

For example, it is possible for more second layers of composite material to be present on the rear side of the seat according to the invention than are first layers present on the front side of the seat according to the invention or for more first layers of composite material to be present on the front side of the seat according to the invention than are second layers present on the rear side of the seat according to the invention. The presence of more layers of composite material on one side of the seat according to the invention than on the other side of the seat according to the invention improves, for example, the mechanical properties of the seat, in particular during the use thereof or in the event of unintended deformation in the case of an accident.

It is also possible and preferred according to the invention that more second layers of composite material are present on the rear side of the seat according to the invention in particular regions of the seat according to the invention, for example in the backrest part, in the seat part and/or in the region connecting the backrest part and the seat part, than are first layers present in the corresponding region of the front side. For example, particular preference is given to more second layers of composite material being present on the rear side in the region connecting the backrest part and the seat part than are first layers of composite material present in the corresponding region of the front side.

For the purposes of the present invention, “more” means that at least one layer more is present on one side of the seat than on the opposite side.

A particularly preferred embodiment of the present invention therefore provides the seat according to the invention in which there is at least one more layer of composite material containing fibers present on one side, preferably on the rear side, than on the other side, preferably the front side, in the connecting region.

More preferably, there are from 3 to 30, particularly preferably from 5 to 15, in particular from 2 to 8, very particularly preferably from 3 to 5, second layers of composite material present on the rear side of the seat according to the invention.

There are preferably from 1 to 10, particularly preferably from 1 to 7, in particular from 3 to 5 or from 1 to 3, first layers of composite material present on the front side of the seat according to the invention.

More preferably, there are from 3 to 30, particularly preferably from 5 to 15, in particular from 2 to 8, very particularly preferably from 3 to 5, second layers of composite material present on the rear side of the seat according to the invention, while there are preferably from 1 to 10, particularly preferably from 1 to 7, in particular from 3 to 5 or from 1 to 3, first layers of composite material present on the front side of the seat according to the invention, with in each case at least one more second layer being present on the rear side than are first layers present on the front side.

More preferably, there are from 3 to 20, preferably from 5 to 15, second layers of composite material present in particular regions of the rear side, for example the backrest part, the seat part and/or the region connecting the backrest part and the seat part, especially in the region connecting the backrest part and the seat part, of the seat according to the invention, while there are from 1 to 10, preferably from 3 to 10, first layers of composite material present on the front side of the corresponding region of the seat according to the invention, with in each case at least one second layer more being present on the rear side than are first layers present on the front side.

More preferably, there are more layers of composite material present in particular regions of one side, i.e. either the rear side or the front side, for example the backrest part, the seat part and/or the region connecting the backrest part and the seat part, especially in the region connecting the backrest part and the seat part, than in the other regions of the same side. For example, there are from 3 to 20, preferably from 5 to 15, layers of composite material present in one of the abovementioned regions of a side of the seat according to the invention, while there are from 1 to 10, preferably from 3 to 5, layers of composite material present in the other regions of the same side of the seat, with in each case at least one more layer being present in the first-named region than there are layers in the other regions.

There are particularly preferably in each case more first layers of composite material present in the region of the front side of the seat according to the invention connecting the backrest part and the seat part than are second layers present in the other regions, i.e. the seat part or the backrest part, of the front side.

More preferably, there are in each case more second layers of composite material present in the region of the rear side of the seat according to the invention connecting the backrest part and the seat part than in the other regions, i.e. the seat part or the backrest part, of the rear side.

If there is more than one layer of composite material present in the seat according to the invention, it is possible for the layers present to be arranged so that the continuous fibers present therein run parallel, i.e. the angle between continuous fibers of two superposed layers is essentially 0°.

Furthermore, it is possible and preferred that, if more than one layer of composite material is present, the layers present are arranged so that the continuous fibers present therein do not run parallel, i.e. the angle between continuous fibers of two corresponding different layers is essentially not 0°.

Further preference is given to in each case more than one first or more than one second layer of composite material being present above one another in the seat according to the invention and the continuous fibers in adjacent layers being at an angle of from 30° to 130° to one another.

For example, the continuous fibers in adjacent layers and/or in the at least one first layer and in the at least one second layer in different components of the seat according to the invention can be at an angle of 30°, 40°, 45°, 50°, 60°, 70°, 80°, 90°, 100°, 110°, 120° or 130° to one another. In each case the orientation may deviate from the abovementioned guide values by ±5°, preferably by ±3°, more preferably by ±1°.

Particular preference is given to there being more first layers or more second layers present in the seat according to the invention, with the unidirectionally oriented continuous fibers of corresponding adjacent layers preferably being at an angle of from 60 to 120°, preferably from 80 to 100°, for example 80°, 900 or 100°, to one another.

According to the invention, the unidirectionally oriented continuous fibers in the at least one first layer and/or in the at least one second layer and/or in various parts of the seat according to the invention, i.e. the seat part, the backrest part and/or the region connecting the seat part and the backrest part, are more preferably arranged parallel to one another or at an angle of from 30° to 130° to one another, with the individual angles being able to be different, i.e. preferably differing by, for example, from 5° to 120°.

According to the invention, a different orientation of the unidirectionally oriented continuous fibers relative to one another preferably extends only over parts of the front side and/or rear side. Furthermore, a different number of the first layers and the second layers preferably extends only over parts of the front side and/or rear side.

An increased stability of the seat according to the invention in particular, particularly stressed, regions is ensured according to the invention by these preferred and particularly preferred embodiments.

The present invention therefore also provides the seat according to the invention for a vehicle, preferably for a land vehicle, for a watercraft and/or for an aircraft, comprising at least one multilayer structural component comprising at least one first and at least one second layer of composite material, in each case containing fibers which are embedded in a thermoplastic polymer, and a layer of at least one foamed thermoplastic polymer arranged in between,

wherein the fibers are in each case unidirectionally oriented continuous fibers and the unidirectionally oriented continuous fibers in the at least one first layer and/or in the at least one second layer and/or in various parts of the seat according to the invention are arranged parallel to one another or at an angle of from 300 to 1300 to one another, with the individual angles being able to be different, i.e. preferably differing by, for example, from 5° to 120°.

More preferably, the present invention provides the seat according to the invention for a vehicle, preferably for a land vehicle, for a watercraft and/or for an aircraft, comprising at least one multilayer structural component comprising at least one first and at least one second layer of composite material, in each case containing fibers which are embedded in a thermoplastic polymer, and a layer of at least one foamed thermoplastic polymer arranged in between, wherein the fibers are in each case unidirectionally oriented continuous fibers, wherein the number of first and second layers of composite material present on the front side and the rear side of the seat according to the invention and/or in various regions of the seat, for example backrest part, seat part and the region connecting the backrest part and the seat part, is not the same

and/or

the unidirectionally oriented continuous fibers in the at least one first layer and/or in the at least one second layer and/or in various parts of the seat according to the invention are arranged parallel to one another or at an angle of from 300 to 1300 to one another, with the individual angles being able to be different, i.e. preferably differing by, for example, from 5° to 120°.

If more than one first layer or more than one second layer is present according to the invention, the respective layers can be made up essentially identically or differently, preferably essentially identically.

For the purposes of the invention, the expression “an essentially identical make-up of the corresponding layers of composite material” means that at least one feature selected from the group consisting of chemical composition, fiber volume content and layer thickness is identical. The expression “chemical composition” encompasses, for the purposes of the invention, the chemical composition of the polymer matrix of the composite material, the chemical composition of the continuous fibers and/or the composition of the fiber size.

The at least one multilayer structural component present in the seat according to the invention comprises a layer of at least one foamed thermoplastic polymer between the at least one first and the at least one second layer of composite material.

Fundamentally, any foamed thermoplastic polymer known to a person skilled in the art can be used for the purposes of the invention.

In a preferred embodiment, the foamed thermoplastic polymer present in the seat according to the invention is a thermoplastic polymer which is not formed from appropriate precursor compounds and foamed only after being placed between the first layer of composite material and the second layer of composite material. According to the invention, preference is given to a fully foamed thermoplastic polymer being introduced between the first layer of composite material and the second layer of composite material and joined to the layers during production of the seat according to the invention.

The foamed thermoplastic polymer present according to the invention is preferably selected from the group consisting of polycarbonate, polyamide, polyester, polylactide, polyether, thermoplastic polyurethane, polyacetal, fluoropolymer, polyether sulfone, polyolefin, in particular polyethylene and polypropylene, polyimide, polyacrylate, polyphenylene oxide, polyphenylene sulfide, polyether ketone, polyaryl ether ketone, styrene polymers, in particular polystyrene, styrene copolymers, in particular styrene-acrylonitrile copolymer, acrylonitrile-butadiene-styrene block copolymers, polyvinyl chloride, polyethylene terephthalate and mixtures thereof.

A foamed polymer based on homopolycarbonate and/or copolycarbonate is preferably present as foamed thermoplastic polymer for the purposes of the invention.

Due to a homopolycarbonate- and/or copolycarbonate-based polymer preferably being used as foamed thermoplastic polymer and the fibers, preferably the continuous fibers, in the composite material preferably likewise being embedded in a homopolycarbonate- and/or copolycarbonate-based polymer, it is possible according to the invention to provide a structural part which can be recycled particularly advantageously and efficiently.

The density of the foamed thermoplastic polymer present, in particular the foamed homopolycarbonate- and/or copolycarbonate-based polymer, is generally from 0.03 to 0.7 g/cm³, preferably from 0.15 to 0.5 g/cm³, particularly preferably from 0.2 to 0.25 g/cm³.

For the particles used according to the invention, a polycarbonate-based polymer is, for the purposes of the present invention, a polymer which contains at least 50% by weight, preferably at least 60% by weight, more preferably at least 70% by weight, in particular at least 80% by weight, particularly preferably at least 90% by weight, very particularly preferably at least 95% by weight, in particular at least 97% by weight, of polycarbonate. In other words, a polycarbonate-based polymer can, for the purposes of the present invention, contain not more than 50% by weight, preferably not more than 40% by weight, more preferably not more than 30% by weight, in particular not more than 20% by weight, particularly preferably not more than 10% by weight, very particularly preferably not more than 5% by weight, in particular not more than 3% by weight, of one or more polymers other than polycarbonate as blend partners.

In a particular embodiment, the polycarbonate-based polymer used for the foamed particles consists essentially, in particular to an extent of 100% by weight, of polycarbonate.

In a particular embodiment of the invention, the polycarbonate-based polymer consists to an extent of 70% by weight, 80% by weight, 90% by weight or essentially, in particular to an extent of 100% by weight, of a linear polycarbonate.

The polycarbonates can be produced in a known manner from diphenols, carbonic acid derivatives, optionally chain terminators and branching agents.

Particulars pertaining to the production of polycarbonates have been well known to a person skilled in the art for at least about 40 years. Corresponding literature references have been mentioned above.

The production of polycarbonates is known per se to a person skilled in the art and has likewise already been described above.

Diphenols suitable for the production of the polycarbonates are, for example, hydroquinone, resorcinol, dihydroxybiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from isatin derivatives or from phenolphthalein derivatives, and also the related ring-alkylated, ring-arylated and ring-halogenated compounds.

Preferably employed diphenols are those based on phthalimides, for example 2-aralkyl-3,3′-bis(4-hydroxyphenyl)phthalimides or 2-aryl-3,3′-bis(4-hydroxyphenyl)phthalimides such as 2-phenyl-3,3′-bis(4-hydroxyphenyl)phthalimide, 2-alkyl-3,3′-bis(4-hydroxyphenyl)phthalimides, such as 2-butyl-3,3′-bis(4-hydroxyphenyl)phthalimides, 2-propyl-3,3′-bis(4-hydroxyphenyl)phthalimides, 2-ethyl-3,3′-bis(4-hydroxyphenyl)phthalimides or 2-methyl-3,3′-bis(4-hydroxyphenyl)phthalimides and also diphenols based on isatins substituted at the nitrogen, such as 3,3-bis(4-hydroxyphenyl)-1-phenyl-1H-indol-2-one or 2,2-bis(4-hydroxyphenyl)-1-phenyl-1H-indol-3-one.

Preferred diphenols are 4,4′-dihydroxybiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane.

Particularly preferred diphenols are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane and dimethylbisphenol A.

These and other suitable diphenols are described for example in U.S. Pat. Nos. 3,028,635, 2,999,825, 3,148,172, 2,991,273, 3,271,367, 4,982,014 and 2,999,846, in DE-A 1 570 703, DE-A 2 063 050, DE-A 2 036 052, DE-A 2 211 956 and DE-A 3 832 396, in FR-A 1 561 518, in the monograph H. Schnell, Chemistry and Physics of Polycarbonates, Interscience Publishers, New York 1964 and also in JP-A 620391986, JP-A 620401986 and JP-A 1055501986.

In the case of homopolycarbonates, only one diphenol is employed, and in the case of copolycarbonates, two or more diphenols are employed.

Examples of suitable carbonic acid derivatives are phosgene or diphenyl carbonate.

Suitable chain terminators that may be used in the production of the polycarbonates are monophenols. Suitable monophenols are for example phenol itself, alkylphenols such as cresols, p-tert-butylphenol, cumylphenol and mixtures thereof.

Preferred chain terminators are phenols which are monosubstituted or polysubstituted with linear or branched, preferably unsubstituted C1-C30-alkyl radicals or with tert-butyl. Particularly preferred chain terminators are phenol, cumylphenol and/or p-tert-butylphenol. The amount of chain terminator to be used is preferably from 0.1 to 5 mol %, based on moles of diphenols used in each case. The chain terminators can be added before, during or after the reaction with a carbonic acid derivative.

Suitable branching agents are the trifunctional or more than trifunctional compounds known in polycarbonate chemistry, in particular those having three or more than three phenolic OH groups.

Suitable branching agents are for example 1,3,5-tri(4-hydroxyphenyl)benzene, 1,1,1-tri(4-hydroxyphenyl)ethane, tri(4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane and 1,4-bis((4′,4-dihydroxytriphenyl)methyl)benzene and 3,3-bis(3-methyl-4-hydroxyphenyl)-2-oxo-2,3-dihydroindole.

The amount of the branching agents which are optionally to be used is preferably from 0.05 mol % to 3.00 mol %, based on moles of diphenols used in each case. The branching agents can either be initially charged with the diphenols and the chain terminators in the aqueous alkaline phase or added dissolved in an organic solvent before the phosgenation. In the case of the transesterification process, the branching agents are employed together with the diphenols.

Particularly preferred polycarbonates are the homopolycarbonate based on bisphenol A, the homopolycarbonate based on 1,3-bis(4-hydroxyphenyl)-3,3,5-trimethylcyclohexane and the copolycarbonates based on the two monomers bisphenol A and 1,1-bis(4-hydroxyphenyl)-3,3,5-trimethylcyclohexane.

Furthermore, copolycarbonates may also be used. To produce these copolycarbonates, it is possible to use from 1 to 25% by weight, preferably from 2.5 to 25% by weight, particularly preferably from 2.5 to 10% by weight, based on the total amount of diphenols to be used, of poly diorganosiloxanes having hydroxyaryloxy end groups. These are known (U.S. Pat. Nos. 3,419,634, 3,189,662, EP 0 122 535, U.S. Pat. No. 5,227,449) and can be produced by methods known in the literature. Polydiorganosiloxane-containing copolycarbonates are likewise suitable; the production of the polydiorganosiloxane-containing copolycarbonates is described, for example, in DE-A 3 334 782.

The polycarbonates may be present alone or as a mixture of polycarbonates. It is also possible to employ the polycarbonate or the mixture of polycarbonates together with one or more polymers other than polycarbonate as blend partners.

As blend partners, it is possible to use polyamides, polyesters, in particular polybutylene terephthalate and polyethylene terephthalate, polylactide, polyether, thermoplastic polyurethane, polyacetal, fluoropolymer, in particular polyvinylidene fluoride, polyether sulfones, polyolefin, in particular polyethylene and polypropylene, polyimide, polyacrylate, in particular poly(methyl)methacrylate, polyphenylene oxide, polyphenylene sulfide, polyether ketone, polyaryl ether ketone, styrene polymers, in particular polystyrene, styrene copolymers, in particular styrene-acrylonitrile copolymer, acrylonitrile-butadiene-styrene block copolymers and polyvinyl chloride.

In addition, up to 10.0% by weight, preferably from 0.10 to 8.0% by weight, particularly preferably from 0.2 to 3.0% by weight, of other customary additives are optionally present.

Additives which are suitable for the purposes of the invention are, for example, selected from the group consisting of flame retardants, anti-drip agents, thermal stabilizers, mold release agents, antioxidants, UV absorbers, IR absorbers, antistatics, optical brighteners, light-scattering agents, colorants such as pigments, including inorganic pigments, carbon black and/or dyes, inorganic fillers and mixtures thereof. These additives may be added individually or else in a mixture.

Additives of this type as are customarily added to polycarbonates are described, for example, in EP-A 0 839 623, WO-A 96/15102 or EP-A 0 500 496.

Homopolycarbonate- and/or copolycarbonate-based polymers which are preferably used according to the invention in the foamed particles generally have a melt viscosity which ensures good processability for the purposes of the present invention. In a preferred embodiment, the homopolycarbonate- and/or copolycarbonate-based polymers used have a melt viscosity of from 100 to 2000 Pa*s, more preferably from 130 to 1300 Pa*s. The determination of the melt viscosity is carried out using the high-pressure capillary rheometer as set forth in ISO 11443 of 04-2014.

Homopolycarbonate- and/or copolycarbonate-based polymers which are preferably used according to the invention generally have a molecular weight which ensures good processability for the purposes of the present invention. In a preferred embodiment, the homopolycarbonate- and/or copolycarbonate-based polymers used have a molecular weight of from 24 000 to 33 000 g/mol, more preferably from 26 000 to 31 000 g/mol. The determination of the molecular weight is carried out by GPC analysis in accordance with DIN EN ISO/IEC 17025 of 03-2018.

In a preferred embodiment, the present invention provides the seat according to the invention in which at least one protective coating, decorative coating, coating which improves the feel and/or coating which improves the seating comfort is/are present on the outside of the first and/or the second layer of composite material.

Corresponding coatings are known per se to a person skilled in the art. A protective coating is, for example, selected from among clear varnish and/or a hardcoat finish. A decorative coating is, for example, selected from among artificial leathers known to a person skilled in the art. A coating which improves the feel is, for example, selected from among softtouch coatings. A coating which improves the seating comfort is, for example, realized by applying a layer of a thermoplastic polyurethane known to a person skilled in the art. According to the invention, it is possible and preferred that such coatings are not applied to the entire area of the seat according to the invention but instead only to part thereof. An advantage of this embodiment is that the abovementioned requirements for a seat for a vehicle are satisfied at relatively low cost and with relatively little effort by means of such coatings.

The present invention also provides the process for producing a seat according to the invention, comprising at least the following steps:
(A) provision of at least one first and at least one second layer of composite material, in each case containing fibers which in each case are embedded in a thermoplastic polymer,
(B) thermoforming of the at least one first layer of composite material to form a lower seat shell,
(C) thermoforming of the at least one second layer of composite material to form an upper seat shell,
(D) positioning of the lower seat shell and the upper seat shell in a tool so that a gap is formed between the two seat shells,
(E) introduction of foamed particles composed of a thermoplastic polymer into the gap and
(F) pressing together the two seat shells and the foamed particles in order to obtain the seat.

The individual steps of the process according to the invention are described in detail below. Step (A) of the process according to the invention comprises the provision of at least one first and at least one second layer of composite material, in each case containing fibers which in each case are embedded in a thermoplastic polymer.

What has been said in respect of the at least one first layer and the at least one second layer applies analogously to the process according to the invention, in particular step (A).

At least one first layer of composite material and at least one second layer of composite material with appropriate dimensions are preferably provided in step. The appropriate dimensions are given by the dimensions of the seat to be produced plus further material which is necessary in order to bring the preferably flat or essentially flat layers provided in step into a three-dimensional shape in steps (B) and (C). Furthermore, further material which is parted, preferably cut off, from the edges of the seat shells produced after the thermoforming in steps (B) and (C) is preferably required at the edges of the layers provided. For example, from 5 to 10 cm of additional material are provided according to the invention at the edges of the layers of composite material used.

The at least one first layer and the at least one second layer provided according to the invention in step (A) each generally have a thickness of from 30 to 1000 μm, preferably from 50 to 500 μm, particularly preferably from 175 to 300 μm. According to the invention, the at least one first layer and the at least one second layer can have the same thickness or have different thicknesses.

In a preferred embodiment of the present invention, more than one first layer of composite material and/or more than one second layer of composite material are used. In this embodiment, step (A) also comprises the provision of an appropriate number of layers.

In the case according to the invention of more than one first layer of composite material being present and the individual first layers being arranged so that the fibers present therein, in particular continuous fibers, in adjacent first layers are oriented parallel to one another, the individual first layers are preferably oriented relative to one another in step (A) so that the fibers, in particular the continuous fibers, in adjacent second layers are parallel to one another. If more than one layer of composite material is used according to the invention, the individual layers can be joined to one another, preferably pointwise, by methods known to a person skilled in the art, for example by vibrational welding or by means of heating beams.

In the case according to the invention of more than one second layer of composite material being present and the individual second layers being arranged so that the fibers present therein, in particular continuous fibers, in adjacent second layers are oriented parallel to one another, the individual second layers are preferably oriented relative to one another in step (A) so that the fibers, in particular the continuous fibers, in adjacent second layers are parallel to one another.

In the case according to the invention of more than one first layer of composite material being present and the individual first layers being arranged so that the fibers present therein, in particular continuous fibers, in adjacent first layers are not oriented parallel to one another but instead are at a particular angle to one another, for example an angle of from 30° to 130°, for example 30°, 40°, 50°, 60°, 70°, 80°, 90°, 100°, 110°, 1200 or 130°, preferably from 60 to 120°, particularly preferably from 80 to 100°, with the orientation in each case being able to deviate by 5°, preferably by 3°, particularly preferably by ±10, from the abovementioned guide values, the individual first layers are preferably oriented relative to one another in step (A) so that the fibers, in particular the continuous fibers, in adjacent first. layers are at an appropriate angle to one another. For example, it is possible to use three first layers, with the fibers, in particular the continuous fibers, in adjacent layers each being at an angle of 900 to one another. Such a layer sequence would be called “90/0/90”.

In the case according to the invention of more than one second layer of composite material being present and the individual second layers being arranged so that the fibers present therein, in particular continuous fibers, in adjacent second layers are not oriented parallel to one another but are instead at a particular angle to one another, for example an angle of from 30° to 130°, for example 30°, 40°, 50°, 60°, 70°, 80°, 90°, 100°, 110°, 1200 or 130°, preferably from 60 to 120°, particularly preferably from 80 to 100°, with the orientation in each case being able to deviate by 5°, preferably by 3°, particularly preferably by ±1°, from the abovementioned guide values, the individual second layers are preferably oriented relative to one another in step (A) so that the fibers, in particular the continuous fibers, in adjacent second layers are at an appropriate angle to one another. For example, it is possible to use three second layers, with the fibers, in particular the continuous fibers, in adjacent layers each being at an angle of 900 to one another. Such a layer sequence would be called “90/0/90”.

According to the invention, step (A) of the process according to the invention can be followed by all further process steps known to a person skilled in the art before the at least one first layer of composite material is transformed in step (B) or the at least one second layer of composite material is transformed in step (C). Preference is given to no further process steps being carried out between the steps (A) and (B) or (C).

Step (B) of the process according to the invention comprises thermoforming of the at least one first layer of composite material to form a lower seat shell.

The thermoforming of such layers of composite material containing fibers, in particular continuous fibers, which are embedded in a thermoplastic polymer is known per se to a person skilled in the art.

The thermoforming in step (B) of the process according to the invention is preferably carried out in apparatuses known per se to a person skilled in the art, for example in heated steel tools.

The thermoforming in step (B) of the process according to the invention is generally carried out at a temperature of from 180 to 350° C., preferably from 280 to 320° C., particularly preferably from 290 to 300° C.

The thermoforming in step (B) of the process according to the invention is generally carried out at a pressure of from 1 to 200 bar(a), preferably from 10 to 150 bar(a), particularly preferably from 15 to 120 bar(a).

The thermoforming in step (B) of the process according to the invention is generally carried out for a time of from 60 to 180 s, preferably from 80 to 150 s, particularly preferably from 90 to 120 s.

The lower seat shell is obtained after step (B) of the process according to the invention, with overhanging material still possibly being present at the edges due to the thermoforming process. These are, in a preferred embodiment, parted off using methods known to a person skilled in the art, for example by milling or stamping, before the lower seat shell is transferred to step (D).

According to the invention, step (B) of the process according to the invention can be followed by all further process steps known to those skilled in the art using the resulting lower seat shell before the latter is transferred to step (D), for example the above-described parting-off of any overhanging material and/or cleaning of the workpiece.

Step (C) of the process according to the invention comprises thermoforming of the at least one second layer of composite material to form an upper seat shell.

The thermoforming in step (C) of the process according to the invention is preferably carried out in apparatuses known per se to a person skilled in the art, for example heated steel molds.

The thermoforming in step (C) of the process according to the invention is generally carried out at a temperature of from 180 to 350° C., preferably from 280 to 320° C., particularly preferably from 290 to 300° C.

The thermoforming in step (C) of the process according to the invention is generally carried out at a pressure of from 1 to 200 bar(a), preferably from 10 to 150 bar(a), particularly preferably from 15 to 120 bar(a).

The thermoforming in step (C) of the process according to the invention is generally carried out for a time of from 60 to 180 s, preferably from 80 to 150 s, particularly preferably from 90 to 120 s.

The upper seat shell is obtained after step (C) of the process according to the invention, with overhanging material still possibly being present at the edges due to the thermoforming process. These are, in a preferred embodiment, parted off using methods known to a person skilled in the art, for example by milling or stamping, before the upper seat shell is transferred to step (D).

According to the invention, step (C) of the process according to the invention can be followed by all further process steps known to those skilled in the art using the resulting upper seat shell before the latter is transferred to step (D), for example the above-described parting-off of any overhanging material and/or cleaning of the workpiece.

Step (D) of the process according to the invention comprises positioning of the lower seat shell and the upper seat shell in a tool so that a gap is formed between the two seat shells.

In general, step (D) of the process according to the invention can be carried out by all methods known to a person skilled in the art, for example holding by means of vacuum, an electrostatic charge or mechanical intermeshing. In a preferred embodiment, the lower seat shell is firstly placed in an appropriate tool, in particular a press, for example a horizontal or vertical press, in which the subsequent steps are carried out. A layer which prevents adhesion of the lower seat shell to the tool, for example Teflon, is preferably placed or introduced between the inside of the tool and the outside of the lower seat shell.

In a further step, the upper seat shell is then preferably positioned above the lower seat shell in such a way that an appropriate gap is formed between the two seat shells. In a preferred embodiment, this gap is configured like the layer of at least one foamed thermoplastic polymer arranged between the two layers is intended to look in the finished product.

In the case according to the invention of a uniform thickness of the layer composed of at least one foamed thermoplastic polymer being present in the finished seat, the lower seat shell and the upper seat shell are positioned above one another so that an appropriate uniformly thick gap is formed.

In the case according to the invention of a nonuniform thickness of the layer of at least one foamed thermoplastic polymer being present in the finished seat, the lower seat shell and the upper seat shell are positioned above one another so that an appropriate nonuniformly thick gap is formed.

In a preferred embodiment of the present cases, the thickness of the gap formed in step (D) of the process according to the invention is greater than the resulting layer composed of at least one foamed thermoplastic polymer in the finished product, since, for example, the two seat shells are moved further toward one another after introduction of the particles in step (E) of the process according to the invention and/or the thickness of the gap is reduced further by the pressing in step (F) of the process according to the invention.

The gap which is formed in step (D) of the process according to the invention is, for example, from 5 to 200% thicker, preferably from 10 to 100% thicker, particularly preferably from 20 to 50% thicker, than the layer of at least one foamed thermoplastic polymer in the finished seat according to the invention.

According to the invention, step (D) of the process according to the invention can be followed by all further process steps known to a person skilled in the art before step (E) takes place, for example plasma cleaning and/or plasma activation. Preference is given to no further process steps being carried out between the steps (D) and (E).

Step (E) of the process according to the invention comprises introduction of foamed particles composed of a thermoplastic polymer into the gap.

The introduction in step (E) of the process according to the invention can generally be carried out by all methods known to a person skilled in the art. In a preferred embodiment, the foamed particles of a thermoplastic polymer are introduced by means of compressed air through the injectors into the cavity. This is carried out, for example, at ambient temperature and a pressure of from 1 to 10 bar(a).

The foamed particles of a thermoplastic polymer which are used in step (E) of the process according to the invention generally have a density of from 0.05 to 0.6 g/cm³, preferably from 0.2 to 0.25 g/cm³.

The foamed particles of a thermoplastic polymer which are used in step (E) of the process according to the invention generally have a diameter of from 0.5 to 8 mm, preferably from 0.8 to 5 mm, particularly preferably from 1.0 to 3.5 mm.

The foamed particles of a thermoplastic polymer which are used in step (E) of the process according to the invention can generally have any shape, for example spherical, irregular and/or elongated, preferably spherical.

The thermoplastic polymer used for the foamed particles is, for example, selected from the group consisting of homopolycarbonate, copolycarbonate, polyamide, polyester, polyethylene terephthalate, polylactide, polyether, thermoplastic polyurethane, polyacetal, fluoropolymer, polyether sulfone, polyolefin, in particular polyethylene and polypropylene, polyimide, polyacrylate, polyphenylene oxide, polyphenylene sulfide, polyether ketone, polyaryl ether ketone, styrene polymers, in particular polystyrene, styrene copolymers, in particular styrene-acrylonitrile copolymer, acrylonitrile-butadiene-styrene block copolymers, polyvinyl chloride and mixtures thereof.

According to the invention, a foamed homopolycarbonate- and/or copolycarbonate-based polymer is preferably present in the foamed particles.

The foamed particles used in step (F) of the process according to the invention are particularly preferably foamed particles containing
a) a polymer matrix consisting of at least one homopolycarbonate and/or copolycarbonate,
b) optionally further additives, for example flame retardants, color pigments, blowing agents, e.g. pentane, cyclopentane, HFC.

As polymer matrix a), preference is given to using the abovementioned thermoplastic polymers, in particular the abovementioned homopolycarbonate- and/or copolycarbonate-based polymers.

As additives b), it is possible to use, for example, fillers or talc as nucleating agents.

The particles used according to the invention generally have a bulk density of up to 600 g/l, preferably in the range from 100 to 400 g/l, particularly preferably in the range from 150 to 300 g/l. When using fillers, bulk densities in the range above 600 g/l can occur, depending on the type and amount of the filler.

Processes for producing appropriate foamed particles composed of a thermoplastic polymer, in particular of polycarbonate, are known per se to a person skilled in the art and are described, for example, in WO 2012/020112 A1.

According to the invention, step (E) of the process according to the invention can be followed by all further process steps known to a person skilled in the art, in particular a reduction in the gap thickness, for example by closing the tool, before step (F) is carried out.

Step (F) of the process according to the invention comprises pressing together of the two seat shells and the foamed particles in order to obtain the seat.

In a preferred embodiment, step (F) of the process according to the invention also comprises variothermal welding together of the seat shell and the foamed particles. The variothermal process is known per se to a person skilled in the art and is described, for example, in the corresponding chapter of “Spritzgießwerkzeuge Hanser Verlag Christian Hopmann, Georg Menges, Walter Michaeli, Paul Mohren, 7th edition, 2018, ISBN: 978-3-446-45192-6.”

In a further preferred embodiment, step (F) of the process according to the invention can also be carried out by the Atecarma process which is known to a person skilled in the art, see, for example, EP 2 937 379 A1. In this, the foamed particles are functionalized using an aqueous emulsion of a polyolefin, preferably of a polyolefin modified with chlorine and maleic anhydride, these functionalized, foamed particles are heated to a temperature below the melting range of the particles, causing the particles to become joined to one another, and subsequently cooled.

Step (F) of the process according to the invention preferably involves the two parts of the tool which hold the lower seat shell and the upper seat shell, respectively, being moved toward one another so that firstly an appropriate pressure is generated and secondly the gap filled with particles between the lower seat shell and the upper seat shell corresponds to the thickness of the corresponding layer in the seat according to the invention.

In general, step (F) of the process according to the invention can be carried out at any temperature which appears to be suitable to a person skilled in the art, preferably at from 160 to 300° C., particularly preferably at from 200 to 220° C.

In general, step (F) of the process according to the invention can be carried out at any pressure which appears to be suitable to a person skilled in the art, preferably at from 10 to 200 bar(a), particularly preferably at from 15 to 100 bar(a).

In general, step (F) of the process according to the invention can be carried out for any time which appears to be suitable to a person skilled in the art, preferably for from 60 to 300 s, particularly preferably for from 90 to 180 s.

According to the invention, it is preferred that the density of the material present in the gap does not change significantly during the pressing operation in step (F) of the process according to the invention. In particular, the already foamed particles of a thermoplastic polymer which have been introduced into the gap do not foam further during production of the seat according to the invention.

After the actual pressing operation in step (F) of the process according to the invention, the seat produced is preferably taken from the tool, in particular the press. Further process steps known to a person skilled in the art, for example cleaning, removal of any residues of material present, can follow.

The present invention also provides for the use of the seat according to the invention in a vehicle, preferably in a land vehicle, in a watercraft and/or in an aircraft.

The features and preferred embodiments disclosed above in respect of the seat according to the invention apply analogously to the use according to the invention.

### LIST OF REFERENCE NUMERALS

1 multilayer structural part
2 seat part
3 backrest part
4 region connecting the seat part (2) and the backrest part (3)
5 second layer of composite material
6 first layer of composite material
7 layer of at least one foamed thermoplastic polymer
8 rear side, lower seat shell
9 front side, upper seat shell

### DRAWINGS

FIG. 1 shows a side view of the seat according to the invention consisting of a multilayer structural part (1). The multilayer structural part (1) consists of a seat part (2), a backrest part (3) and a region (4) connecting the seat part (2) and the backrest part (3). The multilayer structural part (1) comprises a second layer of composite material (5) and a first layer of composite material (6), in each case containing continuous fibers embedded in polycarbonate. A layer (7) of a foamed polycarbonate is present in between.

FIG. 2 shows a further side view of the seat according to the invention. A plurality of layers of composite material are present on the rear side (8) of the seat. A plurality of layers of composite material (5) are arranged in the region (4) connecting the seat part (2) and the backrest part (3), but these do not extend over the entire rear side (8) of the adjoining backrest part (3) or do not extend over the entire rear side (8) of the adjoining seat part (2). Only one layer of composite material (6) which extends over the entire front side (9) of the backrest part (3) and over the entire front side (9) of the seat part (2) is present on the front side (9).

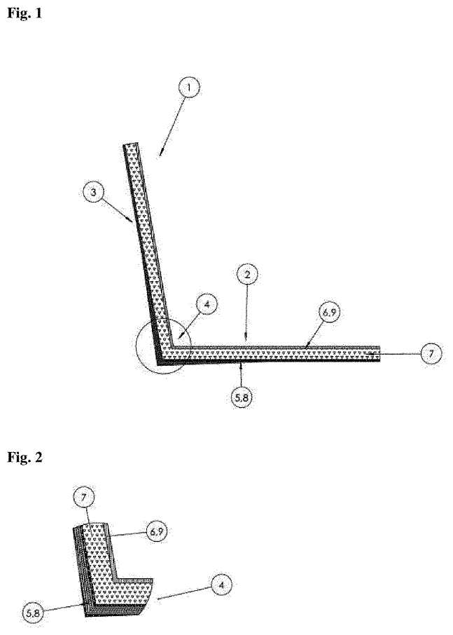

### EXAMPLES

In order to show that the seat according to the invention has advantages in respect of the mechanical strength, in particular in respect of the modulus of elasticity under tension and in bending (tensile modulus or flexural modulus, respectively), the following examples were calculated by methods known to a person skilled in the art:

1. Experimental determination of the mechanical properties of a single layer containing unidirectionally oriented continuous fibers.

The following values were determined:

Tensile modulus in fiber direction: 96 250 MPa, corresponds to about 96 GPa, measured in accordance with ISO 527-5 2010-01
Tensile modulus transverse to the fiber direction: 5950 MPa, corresponds to about 6 GPa, measured in accordance with ISO 527-5 2010-01
Poisson's ratio: 0.29, measured in accordance with ISO 527-5 2010-01
Shear modulus: 2550 MPa, measured in accordance with ISO 14129 1998-02
Thickness of the individual layer: 0.175 mm
2. Theoretical calculation of the tensile modulus and flexural modulus for different layer structures on the basis of the experimental values from 1. with the aid of the laminate theory in the 0° direction and 90° direction.
3. Calculation of the flexural stiffness using the following formula E*I/b (normalized to the breadth) for a rectangular cross section
E from table 1, in the case of flexural modulus
I sheet inertia, for a rectangular cross section: I=(b*h³)/12
b breadth of the cross section
h height of the cross section

The values determined under No. 2 and 3 are reported in table 1.

TABLE 1

| | | | Tensile | | Flexural | | Flexural | |
|---|---|---|---|---|---|---|---|---|
| | Orientation of the | | modulus | | modulus | | stiffness/b | |
| | fibers in the | Thickness | [GPa] | | [GPa] | | [Nmm] | |
| No. | layers [°] | [mm] | 0° | 90° | 0° | 90° | 0° | 90° |
| 1 | 0/0/0/0 | 0.7 | 96 | 6 | 96 | 6 | 2.7 | 0.2 |
| 2 | 0/90/90/0 | 0.7 | 51 | 51 | 85 | 17 | 2.4 | 0.5 |
| 3 | 0/0/0/0/0/0/0/0 | 1.4 | 96 | 6 | 96 | 6 | 22.0 | 1.4 |
| 4 | 0, 90, 90, 0, 0 | 1.4 | 51 | 51 | 60 | 43 | 13.7 | 9.8 |
| 5 | 45, −45, 0, 90, 45 | 1.4 | 36 | 36 | 36 | 27 | 8.2 | 6.2 |
| 6 | 45, 0, −45, 90, 90 | 1.4 | 36 | 36 | 49 | 23 | 11.2 | 5.3 |
| 7 | 30, −30, 0, 90, 30 | 1.4 | 51 | 30 | 60 | 13 | 13.7 | 3.0 |

1.-14. (canceled)

15. A seat for a vehicle comprising at least one multilayer structural component comprising at least one first and at least one second layer of composite material, in each case containing fibers which are embedded in a thermoplastic polymer, and a layer of at least one foamed thermoplastic polymer arranged in between, wherein the number of first and second layers of composite material present on the front side and the rear side of the seat according to the invention and/or in different regions of the seat, for example the backrest part, seat part and the region connecting the backrest part and the seat part, is not the same.

16. A seat for a vehicle, comprising at least one multilayer structural component comprising at least one first and at least one second layer of composite material, in each case containing fibers which are embedded in a thermoplastic polymer, and a layer of at least one foamed thermoplastic polymer arranged in between, wherein the fibers are in each case unidirectionally oriented continuous fibers and the unidirectionally oriented continuous fibers in the at least one first layer and/or in the at least one second layer and/or in various parts of the seat according to the invention can be arranged parallel to one another or at an angle of from 30° to 130°.

17. The seat as claimed in claim 15, wherein the fibers are continuous fibers which are oriented unidirectionally within the respective layer.

18. The seat as claimed in claim 15, wherein in each case more than one first or more than one second layer of composite material are present on top of one another, with the continuous fibers in adjacent layers being at an angle of from 30° to 130° to one another.

19. The seat as claimed in claim 15, wherein the fibers in the composite material are embedded in a homopolycarbonate- and/or copolycarbonate-based polymer.

20. The seat as claimed in claim 15, wherein the foamed thermoplastic polymer is a homopolycarbonate- and/or copolycarbonate-based polymer.

21. The seat as claimed in claim 15, wherein it consists of an appropriately shaped, multilayer structural component.

22. The seat as claimed in claim 21, wherein the multilayer structural component comprises a backrest part, a seat part and a region connecting the backrest part and the seat part.

23. The seat as claimed in claim 15, wherein at least one protective coating, decorative coating, coating which improves the feel and/or coating which improves the seating comfort is present on the outside of the first and/or second layer of composite material.

24. The seat as claimed in claim 15, wherein the density of the foamed thermoplastic polymer is from 0.03 to 0.7 g/cm³.

25. A process for producing a seat as claimed in claim 15, comprising at least the following steps:
(A) provision of at least one first and at least one second layer of composite material, in each case containing fibers which in each case are embedded in a thermoplastic polymer,
(B) thermoforming of the at least one first layer of composite material to form a lower seat shell,
(C) thermoforming of the at least one second layer of composite material to form an upper seat shell,
(D) positioning of the lower seat shell and the upper seat shell in a tool so that a gap is formed between the two seat shells,
(E) introduction of foamed particles composed of a thermoplastic polymer into the gap and
(F) pressing together of the two seat shells and the foamed particles in order to obtain the seat.

26. The process as claimed in claim 25, wherein step (B) and step (C) are each carried out at a temperature of from 290 to 300° C., a pressure of from 10 to 100 bar(a) for a time of from 90 to 120 s.

27. A method comprising utilizing the seat as claimed in claim 15 in a vehicle and/or in an aircraft.

28. The use as claimed in claim 27, wherein the vehicle is a land vehicle.
